(19) United States
(12) Patent Application Publication
(10) Pub. No.: US 2025/0291268 A1
(43) Pub. Date: Sep. 18, 2025

(54) ELECTROSTATIC CHARGE IMAGE DEVELOPING TONER, ELECTROSTATIC CHARGE IMAGE DEVELOPER, TONER CARTRIDGE, PROCESS CARTRIDGE, IMAGE FORMING APPARATUS, AND IMAGE FORMING METHOD

(71) Applicant: FUJIFILM Business Innovation Corp., Tokyo (JP)

(72) Inventors: Reina MURANO, Kanagawa (JP); Yukiko KAMIJO, Kanagawa (JP); Masahiro TAKAYAMA, Kanagawa (JP); Yuka ISHIHARA, Kanagawa (JP); Daisuke NAKASHIMA, Kanagawa (JP)

(73) Assignee: FUJIFILM Business Innovation Corp., Tokyo (JP)

(21) Appl. No.: 18/929,664

(22) Filed: Oct. 29, 2024

(30) Foreign Application Priority Data
Mar. 15, 2024 (JP) 2024-041732

(51) Int. Cl. G03G 9/08

(52) U.S. Cl. CPC G03G 9/0821; G03G 2215/0604; G03G 2215/066; G03G 2221/183

(57) ABSTRACT

An electrostatic charge image developing toner contains toner particles containing a resin and a colorant, in which, in the toner particles, in a case where a Net intensity of a Br element measured by X-ray fluorescence analysis is denoted by IBr and a Net intensity of an S element measured by X-ray fluorescence analysis is denoted by IS, IBr is 1 kcps or more and 30 kcps or less, and IS/IBr is 0.005 or more and 1.2 or less.

### CROSS-REFERENCE TO RELATED APPLICATIONS

This application is based on and claims priority under 35 USC 119 from Japanese Patent Application No. 2024-041732 filed Mar. 15, 2024.

### BACKGROUND

### (i) Technical Field

The present invention relates to an electrostatic charge image developing toner, an electrostatic charge image developer, a toner cartridge, a process cartridge, an image forming apparatus, and an image forming method.

### (ii) Related Art

JP2015-169697A discloses a manufacturing method of a toner for electrophotography consisting of toner particles containing a colorant obtained by a chelate reaction between a coloring agent compound having a specific structure and a copper complex compound having a specific structure, and a binder resin, the manufacturing method including a step of adding an aggregating agent consisting of a compound not containing a metal atom to an aqueous medium in which fine particles of the binder resin, fine particles of the coloring agent compound, and fine particles of the copper complex compound are dispersed to aggregate the fine particles of the binder resin, the fine particles of the coloring agent compound, and the fine particles of the copper complex compound.

JP2018-173558A discloses a magenta toner for electrostatic image development, that contains an amorphous resin and a crystalline polyester resin as a binder resin, and contains, as a colorant, a quinacridone-based pigment having a specific structure, a metal element-containing monoazo pigment having a specific structure, and a naphthol AS-based pigment having a specific structure, in which a total content of the quinacridone-based pigment and the metal element-containing monoazo pigment is 50% to 90% by mass of the entire colorant.

### SUMMARY

Aspects of non-limiting embodiments of the present disclosure relate to an electrostatic charge image developing toner having favorable color formability, as compared with a case where IBr is less than 1 kcps or more than 30 kcps, or IS/IBr is less than 0.005 or more than 1.2.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

Methods for achieving the above-described object include the following aspects.

According to an aspect of the present disclosure, there is provided an electrostatic charge image developing toner containing toner particles containing a resin and a colorant, in which, in the toner particles, in a case where a Net intensity of a Br element measured by X-ray fluorescence analysis is denoted by IBr and a Net intensity of an S element measured by X-ray fluorescence analysis is denoted by IS, IBr is 1 kcps or more and 30 kcps or less, and IS/IBr is 0.005 or more and 1.2 or less.

### BRIEF DESCRIPTION OF THE DRAWINGS

Exemplary embodiment(s) of the present invention will be described in detail based on the following figures, wherein:

FIG. 1 is a view schematically showing the configuration of an example of an image forming apparatus according to the present exemplary embodiment; and

FIG. 2 is a view schematically showing the configuration of an example of a process cartridge detachable from the image forming apparatus according to the present exemplary embodiment.

### DETAILED DESCRIPTION

The exemplary embodiments of the present disclosure will be described below. The following descriptions and examples merely illustrate the exemplary embodiments, and do not limit the scope of the exemplary embodiments.

In the present disclosure, a numerical range described using “to” represents a range including numerical values listed before and after “to” as the minimum value and the maximum value respectively.

Regarding the numerical ranges described in stages in the present disclosure, the upper limit value or lower limit value of a numerical range may be replaced with the upper limit value or lower limit value of another numerical range described in stages. Furthermore, in the present disclosure, the upper limit value or lower limit value of a numerical range may be replaced with values described in examples.

In the present disclosure, the term “step” includes not only an independent step but a step that is not clearly distinguished from other steps as long as the intended purpose of the step is achieved.

In the present disclosure, in a case where an exemplary embodiment is described with reference to drawings, the configuration of the exemplary embodiment is not limited to the configuration shown in the drawings. In addition, the sizes of members in each drawing are conceptual and do not limit the relative relationship between the sizes of the members.

In the present disclosure, each component may include a plurality of corresponding substances. In a case where the amount of each component in a composition is mentioned in the present disclosure, and there are two or more kinds of substances corresponding to each component in the composition, unless otherwise specified, the amount of each component means the total amount of two or more kinds of the substances present in the composition.

In the present disclosure, each component may include two or more kinds of corresponding particles. In a case where there are two or more kinds of particles corresponding to each component in a composition, unless otherwise specified, the particle size of each component means a value for a mixture of two or more kinds of the particles present in the composition.

In the present disclosure, “(meth)acrylic” means at least one of acrylic or methacrylic, and “(meth)acrylate” means at least one of acrylate or methacrylate.

### Electrostatic Charge Image Developing Toner

An electrostatic charge image developing toner (hereinafter, simply referred to as “toner”) according to the present exemplary embodiment contains toner particles containing a resin and a colorant, in which, in the toner particles, in a case where a Net intensity of a Br element measured by X-ray fluorescence analysis is denoted by IBr and a Net intensity of an S element measured by X-ray fluorescence analysis is denoted by IS, IBr is 1 kcps or more and 30 kcps or less, and IS/IBr is 0.005 or more and 1.2 or less.

In the present exemplary embodiment, since the IBr and the IS/IBr are each within the above-described range, color formability is favorable. The reason is not clear, but is presumed as follows.

In the toner that contains the toner particles containing a resin and a colorant, in a case where the colorant is unevenly distributed in the toner particles, the color formability is likely to be deteriorated, and in a case where the colorant is well dispersed, the color formability is likely to be improved. In addition, by using a toner having favorable color formability, an image with high chroma is easily obtained.

In addition, in a case of toner particles in which bromide ions are appropriately present, it is considered that the respective components such as the colorant are well dispersed by a repulsive force of the bromide ions in the manufacturing process of the toner particles. On the other hand, in a case where the abundant amount of bromide ions is large and the repulsive force of the bromide ions is too strong, the colorant may be unevenly distributed, and the colorant may be likely to aggregate.

Furthermore, it is considered that, in a case of toner particles in which sulfide ions are appropriately present, the bromide ions are well dispersed by a repulsive force between the sulfide ions and the bromide ions in the manufacturing process of the toner particles, and a dispersion effect of the colorant by the bromide ions is further improved. On the other hand, in a case where the abundant amount of sulfide ions is too large with respect to the abundant amount of bromide ions, the repulsive force between the sulfide ions and the bromide ions is too strong, so that the bromide ions are difficult to disperse, and the dispersion effect of the colorant by the bromide ions may be reduced.

On the other hand, in the present exemplary embodiment, IBr and IS/IBr are each within the above-described range. That is, in the present exemplary embodiment, the bromide ions are appropriately present in the toner particles, and the abundant amount of the sulfide ions is also appropriate with respect to the abundant amount of the bromide ions.

Therefore, in the present exemplary embodiment, the dispersion effect of the colorant by the bromide ions is easily obtained in a case where IBr is smaller than the above-described range or IS/IBr is smaller than the above-described range. In addition, in a case where IBr is larger than the above-described range, aggregation of the colorant due to the too strong repulsive force of the bromide ions is suppressed, and the repulsive force between the sulfide ions and the bromide ions is not too strong, and the dispersion effect of the colorant due to the bromide ions is easily obtained, as compared with a case where IS/IBr is larger than the above-described range.

For the above reason, it is presumed that the toner according to the present exemplary embodiment has favorable color formability.

### Net Intensity of Each Element

A method for measuring a Net intensity of each element in the toner particles by X-ray fluorescence analysis is as follows.

140 mg of the toner particles is compressed using a compression molding machine under a load of 10 t for 60 seconds to produce a disk having a diameter of 10 mm. Using the disk as a sample, all-element analysis is performed under the following measurement conditions with a scanning X-ray fluorescence analyzer (ZSX Primus II manufactured by Rigaku Holdings Corporation), and a Net intensity (unit: kilo counts per second; kcps) of each element to be measured is obtained. In a case where the above-described measurement is performed on an externally added toner in which an external additive is attached to the toner particles, the measurement may be performed using toner particles from which the external additive is removed from the externally added toner. In addition, the Net intensity of each element in the toner particles may be calculated by measuring using the external additive toner as it is, instead of the toner particles and correcting the measurement result in consideration of the influence of the external additive.

### Measurement Conditions

Tube voltage: 40 kV
Tube current: 70 mA
Anticathode: rhodium
Measurement time: 15 minutes
Analysis diameter: diameter of 10 mmφ

IBr is 1 kcps or more and 30 kcps or less as described above, and from the viewpoint of obtaining favorable color formability, IBr is, for example, preferably 10 kcps or more and 25 kcps or less, and more preferably 13 kcps or more and 23 kcps or less.

In a case where IBr is equal to or more than the above-described lower limit value, it is presumed that dispersibility of the colorant is improved due to the repulsive force of the bromide ions, and the color formability of the toner is improved. In addition, in a case where IBr is equal to or less than the above-described upper limit value, it is presumed that the aggregation of the colorant due to the excessive repulsive force of the bromide ions is suppressed, and the color formability of the toner is improved.

IBr is a Net intensity measured by X-ray fluorescence analysis, and represents a Br amount contained in the entire (mainly, internal) toner particles. Therefore, examples of a method for controlling IBr within the above-described range include a method of adding a compound containing a bromine atom (hereinafter, also referred to as “bromine-containing compound”) in the manufacturing process of the toner particles, and adjusting the addition amount thereof. The bromine-containing compound may be, for example, an aggregating agent used in a case of manufacturing the toner particles by an aggregation and coalescence method described later.

Examples of the bromine-containing compound include quaternary ammonium salts such as ammonium bromide, dodecyltrimethylammonium bromide, tetramethylammonium bromide, tetradecylammonium bromide, and alkylbenzyl dimethylammonium bromide; iron bromide; zinc bromide; alkali metal bromides such as lithium bromide, sodium bromide, potassium bromide, rubidium bromide, cesium bromide, and francium bromide; and alkaline earth metal bromides such as beryllium bromide, magnesium bromide, strontium bromide, barium bromide, and radium bromide. From the viewpoint of favorable dispersion of each component such as the colorant, the bromine-containing compound is, for example, preferably a quaternary ammonium salt and more preferably a tetraalkylammonium bromide.

Examples of IS include a range of 0.075 kcps or more and 18 kcps or less, and from the viewpoint of obtaining favorable color formability, IS is, for example, preferably 0.3 kcps or more and 10 kcps or less, and more preferably 0.5 kcps or more and 3 kcps or less.

IS/IBr is 0.005 or more and 1.2 or less as described above, and from the viewpoint of obtaining favorable color formability, IS/IBr is, for example, preferably 0.015 or more and 0.08 or less, and more preferably 0.03 or more and 0.06 or less.

In a case where IS/IBr is equal to or more than the above-described lower limit value, it is presumed that the bromide ions are well dispersed by the repulsive force between the sulfide ions and the bromide ions, and the dispersion effect of the colorant by the bromide ions is further improved, so that the color formability of the toner is improved. In addition, in a case where IS/IBr is equal to or less than the above-described upper limit value, it is presumed that the bromide ions are not easily dispersed due to the excessive repulsive force between the sulfide ions and the bromide ions, and the color formability of the toner is improved.

Examples of a method of controlling IS include a method of adding a compound containing a sulfur atom (hereinafter, also referred to as “sulfur-containing compound”) in the manufacturing process of the toner particles, and adjusting the addition amount thereof. The sulfur-containing compound may be, for example, a surfactant used in a case of manufacturing the toner particles by an aggregation and coalescence method described later.

Examples of the sulfur-containing compound include sodium alkylbenzene sulfonates such as sodium dodecylbenzene sulfonate and sodium polyoxyethylene aryl phenyl ether sulfonate; and sodium polyoxyethylene alkyl ether sulfonate. From the viewpoint of the dispersibility of the colorant, the sulfur-containing compound is, for example, preferably a sodium alkylbenzene sulfonate.

In a case where a Net intensity of an O element is denoted by IO, examples of IO include a range of 0.01 kcps or more and 4.0 kcps or less, and from the viewpoint of obtaining favorable color formability, IO is, for example, preferably 0.04 kcps or more and 3.0 kcps or less, and more preferably 0.1 kcps or more and 1.0 kcps or less.

From the viewpoint of obtaining favorable color formability, IBr/IO is, for example, preferably 4.76 or more and 333 or less, more preferably 83.3 or more and 143 or less, and still more preferably 90 or more and 120 or less.

In a case where IBr/O is within the above-described range, the color formability of the toner is improved. The reason is not clear, but is presumed as follows. For example, in a case where the resin contained in the toner particles has an ester bond, examples of a source of the O element present in the toner particles include an oxygen atom of the ester bond contained in the resin. In addition, for example, in a case where the toner particles contain a release agent having an ester bond, the O element may also be derived from an oxygen atom of the ester bond contained in the release agent. Hereinafter, a component from which the O element is derived is also referred to as “O element-derived component”. In a case where IBr/IO is equal to or more than the above-described lower limit value, since the bromide ions are sufficiently present with respect to the oxygen atom, the bromide ions repel negative polarity of the oxygen atom contained in the O element-derived component, so that the O element-derived component is easily dispersed. It is presumed that the dispersibility of the colorant is also improved due to the easy dispersion of the O element-derived component (that is, the resin or the like), so that the color formability of the toner is improved. In addition, in a case where IBr/IO is equal to or less than the above-described upper limit value, it is presumed that uneven distribution of the O element-derived component due to the excessive presence of the bromide ions with respect to the oxygen atom is suppressed, and the decrease in dispersibility of the colorant due to the uneven distribution of the O element-derived component (that is, the resin or the like) is also suppressed, so that the color formability of the toner is improved.

Examples of a method of controlling IO include a method of using a resin containing an oxygen atom as the resin and adjusting the content of the resin; a method of adding a release agent containing an oxygen atom and adjusting the addition amount thereof, a method of adding an oxidizing agent such as ozone to introduce an oxygen atom into the resin or the like, and adjusting the addition amount thereof (that is, adjusting the amount of the oxygen atom to be introduced); and a combination thereof.

Examples of the resin containing an oxygen atom include a polyester resin, an acrylic resin, a styrene acrylic resin, an epoxy resin, a polyurethane resin, a polyamide resin, a cellulose resin, and a polyether resin. The resin containing an oxygen atom may be a resin having a structure with a high oxygen ratio, such as polyvinyl alcohol. As the resin containing an oxygen atom, among the above, from the viewpoint of obtaining favorable color formability, for example, a resin having an ester bond is preferable, a resin having an ester bond in the main chain is more preferable, and a polyester resin is still more preferable. From the viewpoint of controlling IBr/IO within the above-described range for obtaining favorable color formability, for example, the resin preferably contains at least one selected from the group consisting of a polyester resin and a styrene acrylic resin, and more preferably contains at least a polyester resin. In order to easily control IBr/IO, the resin may contain both the polyester resin and the styrene acrylic resin.

Examples of the release agent containing an oxygen atom include an ester-based wax, and from the viewpoint of obtaining favorable color formability, for example, a pentaerythritol alkyl ester is preferable among ester-based waxes. In order to easily control IBr/IO, the release agent may include two or more kinds of release agents. Examples of a combination of two or more kinds of release agents include a combination of an ester-based wax and a hydrocarbon-based wax.

The oxidizing agent is not particularly limited as long as the oxidizing agent is a compound that introduces an oxygen atom into the resin or the like, and examples thereof include ozone.

Hereinafter, the toner according to the present exemplary embodiment will be described in detail.

The toner according to the present exemplary embodiment contains toner particles. The toner according to the present exemplary embodiment may contain an external additive.

### Toner Particles

The toner particles contain, for example, a resin. The toner particles may contain a colorant, a release agent, other additives, and the like.

### Resin

Examples of the resin include vinyl-based resins consisting of a homopolymer of a monomer, such as styrenes (for example, styrene, p-chlorostyrene, α-methylstyrene, and the like), (meth)acrylic acid esters (for example, methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, 2-ethylhexyl methacrylate, and the like), ethylenically unsaturated nitriles (acrylonitrile, methacrylonitrile, and the like), vinyl ethers (for example, vinyl methyl ether, vinyl isobutyl ether, and the like), vinyl ketones (for example, vinyl methyl ketone, vinyl ethyl ketone, vinyl isopropenyl ketone, and the like), olefins (for example, ethylene, propylene, butadiene, and the like), or a copolymer obtained by combining two or more kinds of monomers described above.

Examples of the resin include non-vinyl-based resins such as an epoxy resin, a polyester resin, a polyurethane resin, a polyamide resin, a cellulose resin, a polyether resin, and modified rosin, mixtures of these with the vinyl-based resins, or graft polymers obtained by polymerizing a vinyl-based monomer together with the above resins.

One kind of each of these resins may be used alone, or two or more kinds of these resins may be used in combination.

As the resin, for example, a polyester resin is suitable.

Examples of the polyester resin include known amorphous polyester resins. As the polyester resin, a crystalline polyester resin may be used in combination with an amorphous polyester resin. However, a content of the crystalline polyester resin may be, for example, in a range of 2% by mass or more and 40% by mass or less (for example, preferably 2% by mass or more and 20% by mass or less) with respect to all resins.

The “crystalline” resin indicates that a clear endothermic peak is present in differential scanning calorimetry (DSC) rather than a stepwise change in endothermic amount and specifically indicates that the half-width of the endothermic peak in a case of measurement at a temperature rising rate of 10 (° C./min) is within 10° C.

On the other hand, the “amorphous” resin indicates that the half-width is higher than 10° C., a stepwise change in endothermic amount is shown, or a clear endothermic peak is not recognized.

### Amorphous Polyester Resin

Examples of the amorphous polyester resin include a polycondensate of a polyvalent carboxylic acid and a polyhydric alcohol. As the amorphous polyester resin, a commercially available product or a synthetic resin may be used.

Examples of the polyvalent carboxylic acid include aliphatic dicarboxylic acids (for example, oxalic acid, malonic acid, maleic acid, fumaric acid, citraconic acid, itaconic acid, glutaconic acid, succinic acid, alkenyl succinic acid, adipic acid, sebacic acid, and the like), alicyclic dicarboxylic acid (for example, cyclohexanedicarboxylic acid and the like), aromatic dicarboxylic acids (for example, terephthalic acid, isophthalic acid, orthophthalic acid, naphthalenedicarboxylic acid, and the like), anhydrides of these, and lower alkyl esters (for example, having 1 or more and 5 or less carbon atoms). Among these, for example, aromatic dicarboxylic acids are preferable as the polyvalent carboxylic acid.

As the polyvalent carboxylic acid, a carboxylic acid having a valency of 3 or more that has a crosslinked structure or a branched structure may be used in combination with a dicarboxylic acid. Examples of the carboxylic acid having a valency of 3 or more include trimellitic acid, pyromellitic acid, anhydrides of these acids, and lower alkyl esters (for example, having 1 or more and 5 or less carbon atoms) of these acids.

One kind of polyvalent carboxylic acid may be used alone, or two or more kinds of polyvalent carboxylic acids may be used in combination.

Examples of the polyhydric alcohol include aliphatic diols (for example, ethylene glycol, diethylene glycol, triethylene glycol, propylene glycol, butanediol, hexanediol, neopentyl glycol, and the like), alicyclic diols (for example, cyclohexanediol, cyclohexanedimethanol, hydrogenated bisphenol A, and the like), and aromatic diols (for example, an ethylene oxide adduct of bisphenol A, a propylene oxide adduct of bisphenol A, and the like). Among the polyhydric alcohols, for example, an aromatic diol or an alicyclic diol is preferable, and an aromatic diol is more preferable.

As the polyhydric alcohol, a polyhydric alcohol having three or more hydroxyl groups and a crosslinked structure or a branched structure may be used in combination with a diol. Examples of the polyhydric alcohol having three or more hydroxyl groups include glycerin, trimethylolpropane, and pentaerythritol.

One kind of polyhydric alcohol may be used alone, or two or more kinds of polyhydric alcohols may be used in combination.

The glass transition temperature (Tg) of the amorphous polyester resin is, for example, preferably 50° C. or higher and 80° C. or lower, and more preferably 50° C. or higher and 65° C. or lower.

The glass transition temperature is determined from a DSC curve obtained by differential scanning calorimetry (DSC). More specifically, the glass transition temperature is determined by “extrapolated glass transition onset temperature” described in the method for determining a glass transition temperature in JIS K 7121-1987, “Testing methods for transition temperatures of plastics”.

The weight-average molecular weight (Mw) of the amorphous polyester resin is, for example, preferably 5,000 or more and 1,000,000 or less, and more preferably 7,000 or more and 500,000 or less.

The number-average molecular weight (Mn) of the amorphous polyester resin is, for example, preferably 2,000 or more and 100,000 or less.

The molecular weight distribution Mw/Mn of the amorphous polyester resin is, for example, preferably 1.5 or more and 100 or less, and more preferably 2 or more and 60 or less.

The weight-average molecular weight and the number-average molecular weight are measured by gel permeation chromatography (GPC). By GPC, the molecular weight is measured using GPC HLC-8120GPC manufactured by Tosoh Corporation as a measurement device, TSKgel Super HM-M (15 cm) manufactured by Tosoh Corporation as a column, and THE as a solvent. The weight-average molecular weight and the number-average molecular weight are calculated using a molecular weight calibration curve plotted using a monodisperse polystyrene standard sample from the measurement results.

The amorphous polyester resin is obtained by a well-known manufacturing method. Specifically, for example, the polyester resin is obtained by a method of setting a polymerization temperature to 180° C. or higher and 230° C. or lower, reducing the internal pressure of a reaction system as necessary, and carrying out a reaction while removing water or an alcohol generated during condensation.

In a case where monomers as raw materials are not dissolved or compatible at the reaction temperature, in order to dissolve the monomers, a solvent having a high boiling point may be added as a solubilizer. In this case, a polycondensation reaction is carried out in a state where the solubilizer is distilled off. In a case where a monomer with poor compatibility takes part in the reaction, for example, the monomer with poor compatibility may be condensed in advance with an acid or an alcohol that is to be polycondensed with the monomer, and then polycondensed together with the main component.

### Crystalline Polyester Resin

Examples of the crystalline polyester resin include a polycondensate of polyvalent carboxylic acid and polyhydric alcohol. As the crystalline polyester resin, a commercially available product or a synthetic resin may be used.

Here, since the crystalline polyester resin easily forms a crystal structure, the crystalline polyester resin is, for example, preferably a polycondensate that is not formed of an aromatic-containing polymerizable monomer but is formed of a linear aliphatic polymerizable monomer.

Examples of the polyvalent carboxylic acid include aliphatic dicarboxylic acids (such as oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid), aromatic dicarboxylic acids (such as dibasic acids such as phthalic acid, isophthalic acid, terephthalic acid, and naphthalene-2,6-dicarboxylic acid), anhydrides of these dicarboxylic acids, and lower alkyl esters (for example, having 1 or more and 5 or less carbon atoms) of these dicarboxylic acids.

As the polyvalent carboxylic acid, a carboxylic acid having a valency of 3 or more that has a crosslinked structure or a branched structure may be used in combination with a dicarboxylic acid. Examples of the trivalent carboxylic acids include aromatic carboxylic acid (for example, 1,2,3-benzenetricarboxylic acid, 1,2,4-benzenetricarboxylic acid, 1,2,4-naphthalenetricarboxylic acid, and the like), anhydrides of these aromatic carboxylic acids, and lower alkyl esters (for example, having 1 or more and 5 or less carbon atoms) of these aromatic carboxylic acids.

As the polyvalent carboxylic acid, a dicarboxylic acid having a sulfonic acid group or a dicarboxylic acid having an ethylenically double bond may be used together with these dicarboxylic acids.

One kind of polyvalent carboxylic acid may be used alone, or two or more kinds of polyvalent carboxylic acids may be used in combination.

Examples of the polyhydric alcohol include an aliphatic diol (for example, a linear aliphatic diol having 7 or more and 20 or less carbon atoms in a main chain portion). Examples of the aliphatic diol include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosanedecanediol. Among the aliphatic diols, for example, 1,8-octanediol, 1,9-nonanediol, or 1,10-decanediol is preferable.

As the polyhydric alcohol, an alcohol having a valency of 3 or more, that forms a crosslinked structure or a branched structure, may be used in combination with the diol. Examples of the alcohol having a valency of 3 or more include glycerin, trimethylolethane, and trimethylolpropane, pentaerythritol.

One kind of polyhydric alcohol may be used alone, or two or more kinds of polyhydric alcohols may be used in combination.

Here, the content of the aliphatic diol in the polyhydric alcohol may be 80% by mole or more and, for example, preferably 90% by mole or more.

The melting temperature of the crystalline polyester resin is, for example, preferably 50° C. or higher and 100° C. or lower, more preferably 55° C. or higher and 90° C. or lower, and still more preferably 60° C. or higher and 85° C. or lower.

The melting temperature is determined from a DSC curve obtained by differential scanning calorimetry (DSC) by “peak melting temperature” described in the method for determining the melting temperature in JIS K7121-1987, “Testing methods for transition temperatures of plastics”.

The weight-average molecular weight (Mw) of the crystalline polyester resin is, for example, preferably 6,000 or more and 35,000 or less.

The crystalline polyester resin can be obtained by a well-known manufacturing method, for example, same as the amorphous polyester resin.

In a case where the resin contains a polyester resin, a content of the polyester resin with respect to the entire resin is, for example, 20% by mass or more and 100% by mass or less, preferably 40% by mass or more and 100% by mass.

Examples of the resin also include a vinyl-based resin.

The vinyl-based resin will be described.

Examples of the vinyl-based resin include vinyl-based resins consisting of a homopolymer of a monomer, such as styrenes (for example, styrene, p-chlorostyrene, α-methylstyrene, and the like), (meth)acrylic acid esters (for example, methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, 2-ethylhexyl methacrylate, and the like), ethylenically unsaturated nitriles (for example, acrylonitrile, methacrylonitrile, and the like), vinyl ethers (for example, vinyl methyl ether, vinyl isobutyl ether, and the like), vinyl ketones (for example, vinyl methyl ketone, vinyl ethyl ketone, vinyl isopropenyl ketone, and the like), olefins (for example, ethylene, propylene, butadiene, and the like), or a copolymer obtained by combining two or more kinds of monomers described above.

One kind of each of these vinyl-based resins may be used alone, or two or more kinds of these vinyl-based resins may be used in combination.

As the vinyl-based resin, for example, a styrene acrylic resin is preferable from the viewpoint of excellent environmental stability of toner charging.

The styrene acrylic resin is a copolymer obtained by copolymerizing at least a styrene-based monomer (a monomer having a styrene skeleton) and a (meth)acrylic monomer (a monomer containing a (meth)acryloyl group and, for example, preferably a monomer containing a (meth)acryloyloxy group). The styrene acrylic resin includes, for example, a copolymer of a monomer of styrenes and a monomer of (meth)acrylic acid esters described above. The acrylic resin portion in the styrene acrylic resin is any one of an acrylic monomer or a methacrylic monomer, or a partial structure obtained by polymerizing the monomers. In addition, “(meth)acrylic” is an expression including both of “acrylic” and “methacrylic”.

Specific examples of the styrene-based monomer include styrene, alkyl-substituted styrene (such as α-methylstyrene, 2-methylstyrene, 3-methylstyrene, 4-methylstyrene, 2-ethylstyrene, 3-ethylstyrene, and 4-ethylstyrene), halogen-substituted styrene (such as 2-chlorostyrene, 3-chlorostyrene, and 4-chlorostyrene), and vinylnaphthalene. The styrene-based monomer may be used alone or in combination of two or more kinds thereof.

Among these, from the viewpoint of ease of reaction, ease of control of reaction, and availability, as the styrene-based monomer, for example, styrene is preferable.

Specific examples of the (meth)acrylic monomer include (meth)acrylic acid and (meth)acrylic acid ester. Examples of the (meth)acrylic acid ester include (meth)acrylic acid alkyl ester (such as methyl (meth)acrylate, ethyl (meth)acrylate, n-propyl (meth)acrylate, n-butyl (meth)acrylate, n-pentyl (meth)acrylate, n-hexyl (meth)acrylate, n-heptyl (meth)acrylate, n-octyl (meth)acrylate, n-decyl (meth)acrylate, n-dodecyl (meth)acrylate, n-lauryl (meth)acrylate, n-tetradecyl (meth)acrylate, n-hexadecyl (meth)acrylate, n-octadecyl (meth)acrylate, isopropyl (meth)acrylate, isobutyl (meth)acrylate, t-butyl (meth)acrylate, isopentyl (meth)acrylate, amyl (meth)acrylate, neopentyl (meth)acrylate, isohexyl (meth)acrylate, isoheptyl (meth)acrylate, isooctyl (meth)acrylate, 2-ethylhexyl (meth)acrylate, cyclohexyl (meth)acrylate, and t-butylcyclohexyl (meth)acrylate), (meth)acrylic acid aryl ester (such as phenyl (meth)acrylate, biphenyl (meth)acrylate, diphenylethyl (meth)acrylate, t-butylphenyl (meth)acrylate, and terphenyl (meth)acrylate); dimethylaminoethyl (meth)acrylate, diethylaminoethyl (meth)acrylate, methoxyethyl (meth)acrylate, 2-hydroxyethyl (meth)acrylate, β-carboxyethyl (meth)acrylate, and (meth)acrylamide. The (meth)acrylic monomer may be used alone or in combination of two or more kinds thereof.

Among the (meth)acrylic monomers, from the viewpoint of improving the fixability of the toner, for example, (meth)acrylic acid ester containing an alkyl group having 2 or more and 14 or less carbon atoms (for example, preferably 2 or more and 10 or less carbon atoms and more preferably 3 or more and 8 or less carbon atoms) is preferable among the (meth)acrylic esters. Among these, for example, n-butyl (meth)acrylate is preferable, and n-butyl acrylate is particularly preferable.

The copolymerization ratio of the styrene-based monomer to the (meth)acrylic monomer (on a mass basis, styrene-based monomer/(meth)acrylic monomer) is not particularly limited, but is preferably 98/2 to 60/40.

From the viewpoint of improving the fixability of the toner, the glass transition temperature (Tg) of the styrene acrylic resin is, for example, preferably 40° C. or higher and 75° C. or lower, and more preferably 50° C. or higher and 65° C. or lower.

Here, the glass transition temperature of the resin is determined from a DSC curve obtained by the differential scanning calorimetry (DSC). More specifically, the glass transition temperature of the resin is determined by “extrapolated glass transition onset temperature” described in the method for determining a glass transition temperature in JIS K 7121: 1987, “Testing methods for transition temperatures of plastics”.

From the viewpoint of storage stability of the toner, the weight-average molecular weight of the styrene acrylic resin is, for example, preferably 5,000 or more and 200,000 or less, more preferably 10,000 or more and 100,000 or less, and still more preferably 20,000 or more and 80,000 or less.

A method of producing the styrene acrylic resin is not particularly limited, and various polymerization methods (for example, solution polymerization, precipitation polymerization, suspension polymerization, bulk polymerization, and emulsion polymerization) are applied. In addition, a known operation (for example, a batch type, semi-continuous type, or continuous type operation) is applied to the polymerization reaction.

For example, the toner particles preferably contain at least one selected from the group consisting of the polyester resin and the vinyl-based resin, and may contain both the polyester resin and the vinyl-based resin or may contain only one of the polyester resin or the vinyl-based resin. In a case where the toner particles contain both the polyester resin and the vinyl-based resin, the toner particles may contain both the polyester resin and the vinyl-based resin as a binder resin, or may contain one of the polyester resin or the vinyl-based resin as a binder resin and the other as resin particles. In a case where the toner particles contain one of the polyester resin or the vinyl-based resin as resin particles, the resin particles may have a crosslinked structure.

In a case where the toner particles contain both the polyester resin and the vinyl-based resin, a mass ratio C of the polyester resin to the vinyl-based resin is, for example, 0.7 or more and 10 or less, and may be 1 or more and 6 or less, or 1 or more and 5 or less.

Examples of the resin containing both the polyester resin and the vinyl-based resin include a resin in which the styrene acrylic resin and the polyester resin coexist.

Here, the coexistence of the styrene acrylic resin and the polyester resin can be achieved not only by mixing the respective resins but also by a chemically bonded hybrid resin (so-called styrene acrylic-modified polyester resin) having a styrene acrylic resin segment and a polyester resin segment. Specifically, a hybrid resin can be obtained by using a polyester monomer having an unsaturated structure, such as fumaric acid and succinic acid, or a resin including a monomer structure thereof as a prepolymer, and polymerizing the prepolymer with a vinyl monomer, such as styrene and acrylic.

In a case where the hybrid resin (so-called styrene acrylic-modified polyester resin) is applied, the mass ratio C of the polyester resin to the vinyl-based resin is measured and calculated as a mass ratio of the polyester segment to the vinyl-based resin segment (for example, the styrene-acrylic resin segment) in the hybrid resin. In a case where the hybrid resin, the vinyl-based resin (for example, the styrene acrylic resin), and the polyester resin are used in combination, the mass ratio C of the polyester resin to the vinyl-based resin is measured and calculated as a mass ratio of the sum of the polyester resin segment in the hybrid resin and the polyester resin to the sum of the vinyl-based resin segment in the hybrid resin and the vinyl-based resin.

A content of the resin with respect to the total amount of the toner particles is, for example, preferably 40% by mass or more and 95% by mass or less, more preferably 50% by mass or more and 93% by mass or less, and still more preferably 60% by mass or more and 93% by mass or less.

### Colorant

Examples of the colorant include various pigments such as carbon black, chrome yellow, Hansa yellow, benzidine yellow, threne yellow, quinoline yellow, pigment yellow, permanent orange GTR, pyrazolone orange, vulcan orange, watch young red, permanent red, brilliant carmine 3B, brilliant carmine 6B, Dupont oil red, pyrazolone red, lithol red, rhodamine B lake, lake red C, pigment red, rose bengal, aniline blue, ultramarine blue, calco oil blue, methylene blue chloride, phthalocyanine blue, pigment blue, phthalocyanine green, and malachite green oxalate; and various dyes such as an acridine-based dye, a xanthene-based dye, an azo-based dye, a benzoquinone-based dye, an azine-based dye, an anthraquinone-based dye, a thioindigo-based dye, a dioxazine-based dye, a thiazine-based dye, an azomethine-based dye, an indigo-based dye, a phthalocyanine-based dye, an aniline black-based dye, a polymethine-based dye, a triphenylmethane-based dye, a diphenylmethane-based dye, and a thiazole-based dye.

One kind of colorant may be used alone, or two or more kinds of colorants may be used in combination.

As the colorant, a colorant having undergone a surface treatment as necessary may be used, or a dispersant may be used in combination with the colorant. Furthermore, a plurality of kinds of colorants may be used in combination.

The content of the colorant with respect to the total amount of the toner particles is, for example, preferably 1% by mass or more and 30% by mass or less, and more preferably 3% by mass or more and 15% by mass or less.

### Release Agent

Examples of the release agent include hydrocarbon-based wax; natural wax such as carnauba wax, rice wax, and candelilla wax; synthetic or mineral petroleum-based wax such as montan wax; and ester-based wax such as fatty acid esters and montanic acid esters. The release agent is not limited to the agents.

As the release agent, for example, an ester-based wax is preferable. The ester-based wax is a wax having an ester bond. The ester-based wax may be any of a monoester, a diester, a triester, or a tetraester, and a known natural or synthetic ester-based wax can be adopted. Examples of the ester-based wax include an ester compound of a higher fatty acid (a fatty acid having 10 or more carbon atoms) and a monohydric or polyhydric aliphatic alcohol (an aliphatic alcohol having 8 or more carbon atoms).

Examples of the ester-based wax include an ester compound of a higher fatty acid (caprylic acid, capric acid, lauric acid, myristic acid, palmitic acid, stearic acid, arachidic acid, behenic acid, oleic acid, or montanic acid) and an alcohol (a monohydric alcohol such as methanol, ethanol, propanol, isopropanol, butanol, capryl alcohol, lauryl alcohol, myristyl alcohol, cetyl alcohol, stearyl alcohol, or oleyl alcohols; or a polyhydric alcohol such as glycerin, ethylene glycol, propylene glycol, sorbitol, or pentaerythritol), and specific examples thereof include carnauba wax, rice wax, candelilla wax, jojoba oil, wood wax, beeswax, insect wax, lanolin, and montanic acid ester wax.

The melting temperature of the release agent is, for example, preferably 50° C. or higher and 110° C. or lower, and more preferably 60° C. or higher and 105° C. or lower.

The melting temperature is determined from a DSC curve obtained by differential scanning calorimetry (DSC) by “peak melting temperature” described in the method for determining the melting temperature in JIS K7121-1987, “Testing methods for transition temperatures of plastics”.

The content of the release agent with respect to the total amount of the toner particles is, for example, preferably 1% by mass or more and 20% by mass or less, and more preferably 3% by mass or more and 15% by mass or less.

### Other Additives

Examples of other additives include well-known additives such as a magnetic material, a charge control agent, and inorganic powder. The additives are incorporated into the toner particles as internal additives.

The toner particles may contain a bromine-containing compound as a source of the Br element. Specific examples of the bromine-containing compound are as described above. Examples of a content of the bromine-containing compound with respect to the entire toner particles include a range of 0.04% by mass or more and 0.4% by mass or less, and the content may be in a range of 0.05% by mass or more and 0.3% by mass or less, or in a range of 0.06% by mass or more and 0.25% by mass or less.

The toner particles may contain a sulfur-containing compound as a source of the S element. Specific examples of the sulfur-containing compound are as described above. Examples of a content of the sulfur-containing compound with respect to the entire toner particles include a range of 0.001% by mass or more and 0.02% by mass or less, and the content may be in a range of 0.002% by mass or more and 0.015% by mass or less, or in a range of 0.003% by mass or more and 0.012% by mass or less.

### Characteristics of Toner Particles and the Like

The toner particles may be toner particles that have a single-layer structure or toner particles having a so-called core/shell structure that is configured with a core portion (core particle) and a coating layer (shell layer) coating the core portion.

Here, the toner particles having a core/shell structure may, for example, be configured with a core portion that is configured with a binder resin and other additives used as necessary, such as a colorant and a release agent, and a coating layer that is configured with the binder resin.

The volume-average particle size (D50v) of the toner particles is, for example, preferably 2 μm or more and 10 μm or less, and more preferably 4 μm or more and 8 μm or less.

The various average particle sizes and various particle size distribution indexes of the toner particles are measured using COULTER MULTISIZER II (manufactured by Beckman Coulter, Inc.) and using ISOTON-II (manufactured by Beckman Coulter, Inc.) as an electrolytic solution.

For measurement, a measurement sample in an amount of 0.5 mg or more and 50 mg or less is added to 2 ml of a 5% aqueous solution of a surfactant (for example, preferably sodium alkylbenzene sulfonate) as a dispersant. The obtained solution is added to an electrolytic solution in a volume of 100 ml or more and 150 ml or less.

The electrolytic solution in which the sample is suspended is subjected to a dispersion treatment for 1 minute with an ultrasonic disperser, and the particle size distribution of particles having a particle size in a range of 2 μm or more and 60 μm or less is measured using COULTER MULTISIZER II with an aperture having an aperture size of 100 m. The number of particles to be sampled is 50,000.

For the particle size range (channel) divided based on the measured particle size distribution, a cumulative volume distribution and a cumulative number distribution are plotted from small-sized particles. The particle size at which the cumulative percentage of particles is 16% is defined as volume-based particle size D16v and a number-based particle size D16p. The particle size at which the cumulative percentage of particles is 50% is defined as volume-average particle size D50v and a cumulative number-average particle size D50p. The particle size at which the cumulative percentage of particles is 84% is defined as volume-based particle size D84v and a number-based particle size D84p.

By using these, a volume particle size distribution index (GSDv) is calculated as (D84v/D16v)^{1/2} and a number particle size distribution index (GSDp) is calculated as (D84p/D16p)^{1/2}.

The average circularity of the toner particles is, for example, preferably 0.90 or more and 1.00 or less, and more preferably 0.92 or more and 0.98 or less.

The average circularity of the toner particles is determined by (Equivalent circular perimeter)/(Perimeter) [(Perimeter of circle having the same projected area as particle image)/(Perimeter of projected particle image)]. Specifically, the average circularity is a value measured by the following method.

First, toner particles as a measurement target are collected by suction, and a flat flow of the particles is formed. Thereafter, an instant flash of strobe light is emitted to the particles, and the particles are imaged as a still image. By using a flow-type particle image analyzer (FPIA-3000 manufactured by Sysmex Corporation) performing image analysis on the particle image, the average circularity is determined. The number of samplings for determining the average circularity is 3,500.

In a case where a toner contains the external additive, the toner (developer) as a measurement target is dispersed in water containing a surfactant, then the dispersion is treated with ultrasonic waves such that the external additive is removed, and the toner particles are collected.

### External Additive

Examples of the external additive include inorganic particles. Examples of the inorganic particles include SiO₂, TiO₂, Al₂O₃, SrTiO₃, CuO, ZnO, SnO₂, CeO₂, Fe₂O₃, MgO, BaO, CaO, K₂O, Na₂O, ZrO₂, CaO SiO₂, K₂O·(TiO₂)ₙ, Al₂O₃·2SiO₂, CaCO₃, MgCO₃, BaSO₄, and MgSO₄.

The surface of the inorganic particles as an external additive may have undergone, for example, a hydrophobic treatment. The hydrophobic treatment is performed, for example, by dipping the inorganic particles in a hydrophobic agent. The hydrophobic agent is not particularly limited, and examples thereof include a silane-based coupling agent, silicone oil, a titanate-based coupling agent, and an aluminum-based coupling agent. One kind of each of the agents may be used alone, or two or more kinds of the agents may be used in combination.

Usually, the amount of the hydrophobic agent is, for example, 1 part by mass or more and 10 parts by mass or less with respect to 100 parts by mass of the inorganic particles.

Examples of the external additive also include resin particles (resin particles such as polystyrene, polymethylmethacrylate (PMMA), and melamine resins), a cleaning activator (for example, and a metal salt of a higher fatty acid represented by zinc stearate or fluorine-based polymer particles).

The amount of the external additive externally added with respect to the toner particles is, for example, preferably 0.01% by mass or more and 10% by mass or less, and more preferably 0.01% by mass or more and 6.0% by mass or less.

### Manufacturing Method of Toner

Next, the manufacturing method of the toner according to the present exemplary embodiment will be described.

The toner according to the present exemplary embodiment is obtained by manufacturing toner particles and then externally adding external additives to the toner particles.

The toner particles may be manufactured by any of a dry manufacturing method (for example, a kneading and pulverizing method or the like) or a wet manufacturing method (for example, an aggregation and coalescence method, a suspension polymerization method, a dissolution suspension method, or the like). The manufacturing method of the toner particles is not particularly limited to these manufacturing methods, and a well-known manufacturing method is adopted.

Among the above methods, for example, the aggregation and coalescence method may be used for obtaining toner particles.

Specifically, in a case where the toner particles are manufactured by an aggregation and coalescence method, for example, the toner particles are manufactured through a step (first aggregated particle-forming step) of forming first aggregated particles by mixing a first resin particle dispersion in which first resin particles as a binder resin are dispersed, a colorant dispersion in which a colorant is dispersed, and a release agent particle dispersion in which particles of a release agent (hereinafter, also referred to as “release agent particles”) are dispersed, and aggregating the particles and the colorant in the obtained dispersion; a step (second aggregated particle-forming step) of forming second aggregated particles by, after obtaining the first aggregated particle dispersion in which the first aggregated particles are dispersed, adding second resin particles as a binder resin to the first aggregated particle dispersion, and aggregating the second resin particles on a surface of the first aggregated particles; and a step (coalescence step) of heating the second aggregated particle dispersion in which the second aggregated particles are dispersed to allow the second aggregated particles to undergo coalescence and to form toner particles.

The present aggregation and coalescence method will be described as a method for producing toner particles containing a binder resin, a colorant, and a release agent; but the colorant and the release agent are components to be contained in the toner particles as necessary.

As described above, examples of the method of controlling IBr within the above-described range include a method of adding the bromine-containing compound in the manufacturing process of the toner particles, and adjusting the addition amount thereof. In a case where the toner particles are manufactured by the aggregation and coalescence method, for example, it is preferable to add the bromine-containing compound in at least one of the first aggregated particle-forming step or the second aggregated particle-forming step, and among these, it is more preferable to add the bromine-containing compound in the first aggregated particle-forming step. Examples of an addition amount of the bromine-containing compound with respect to 100 parts by mass of the total amount of components constituting the toner particles include a range of 0.5 parts by mass or more and 3.0 parts by mass or less, and the addition amount may be in a range of 1 part by mass or more and 2.5 parts by mass or less, or in a range of 1.5 parts by mass or more and 2.0 parts by mass or less.

In addition, as described above, examples of the method of controlling IS include a method of adding the sulfur-containing compound in the manufacturing process of the toner particles, and adjusting the addition amount thereof. In a case where the toner particles are manufactured by the aggregation and coalescence method, for example, it is preferable to add the sulfur-containing compound in at least one of the first aggregated particle-forming step or the second aggregated particle-forming step, and among these, it is more preferable to add the sulfur-containing compound in the first aggregated particle-forming step. Examples of an addition amount of the sulfur-containing compound with respect to the 100 parts by mass of the total amount of components constituting the toner particles include a range of 0.003% by mass or more and 0.03% by mass or less, and the addition amount may be in a range of 0.005% by mass or more and 0.02% by mass or less, or in a range of 0.008% by mass or more and 0.012% by mass or less.

In addition, as described above, examples of one of the methods of controlling IO include a method of adding the oxidizing agent such as ozone and adjusting the addition amount thereof. In a case where the toner particles are manufactured by the aggregation and coalescence method, for example, it is preferable to add the oxidizing agent in at least one of the first aggregated particle-forming step or the second aggregated particle-forming step, and among these, it is more preferable to add the oxidizing agent in the first aggregated particle-forming step. In a case where ozone is used as the oxidizing agent, for example, it is preferable to add ozone water, and it is more preferable to add ozone water having a concentration of 2 ppm by mass or more and 8 ppm by mass or less. Examples of an addition amount of the ozone water with respect to 100 parts by mass of the total amount of components constituting the toner particles include a range of 0.005 parts by mass or more and 18 parts by mass or less, and the addition amount may be in a range of 0.008 parts by mass or more and 15 parts by mass or less, or in a range of 0.01 parts by mass or more and 12 parts by mass or less.

Hereinafter, each of the steps will be specifically described.

### Each Dispersion Preparing Step

First, each dispersion to be used in the aggregation and coalescence method is prepared. Specifically, a first resin particle dispersion in which first resin particles as a binder resin are dispersed, a colorant dispersion in which a colorant is dispersed, a second resin particle dispersion in which second resin particles as a binder resin are dispersed, and a release agent particle dispersion in which release agent particles are dispersed are respectively prepared.

In each dispersion preparing step, the first resin particles and the second resin particles will be referred to as “resin particles” in the following description.

The resin particle dispersion is prepared, for example, by dispersing the resin particles in a dispersion medium by using a surfactant.

Examples of the dispersion medium used for the resin particle dispersion include an aqueous medium.

Examples of the aqueous medium include distilled water, water such as deionized water, alcohols, and the like. One kind of each of the media may be used alone, or two or more kinds of the media may be used in combination.

Examples of the surfactant include an anionic surfactant based on a sulfuric acid ester salt, a sulfonate, a phosphoric acid ester, soap, and the like; a cationic surfactant such as an amine salt-type cationic surfactant and a quaternary ammonium salt-type cationic surfactant; a nonionic surfactant based on polyethylene glycol, an alkylphenol ethylene oxide adduct, and a polyhydric alcohol, and the like. Among these, an anionic surfactant and a cationic surfactant are particularly mentioned. The nonionic surfactant may be used in combination with an anionic surfactant or a cationic surfactant.

One kind of surfactant may be used alone, or two or more kinds of surfactants may be used in combination.

As for the resin particle dispersion, examples of the method for dispersing the resin particles in the dispersion medium include general dispersion methods such as a rotary shearing homogenizer, a ball mill having media, a sand mill, and a dyno mill. Depending on the type of resin particles, the resin particles may be dispersed in the resin particle dispersion by using, for example, a transitional phase inversion emulsification method.

The transitional phase inversion emulsification method is a method of dissolving a resin to be dispersed in a hydrophobic organic solvent in which the resin is soluble, adding a base to an organic continuous phase (O phase) for causing neutralization, and then adding an aqueous medium (W phase), such that the resin undergoes conversion (so-called phase inversion) from W/O to O/W, turns into a discontinuous phase, and is dispersed in the aqueous medium in the form of particles.

The volume-average particle size of the resin particles dispersed in the resin particle dispersion is, for example, preferably 0.01 μm or more and 1 μm or less, more preferably 0.08 m or more and 0.8 μm or less, and still more preferably 0.1 μm or more and 0.6 μm or less.

For determining the volume-average particle size of the resin particles, a particle size distribution is measured using a laser diffraction type particle size distribution analyzer (for example, LA-700 manufactured by HORIBA, Ltd.), a volume-based cumulative distribution from small-sized particles is drawn for the particle size range (channel) divided using the particle size distribution, and the particle size of particles accounting for cumulative 50% of all particles is measured as a volume-average particle size D50v. For particles in other dispersions, the volume-average particle size is measured in the same manner.

The content of the resin particles contained in the resin particle dispersion is, for example, preferably 5% by mass or more and 50% by mass or less, and more preferably 10% by mass or more and 40% by mass or less.

For example, a colorant dispersion and a release agent particle dispersion are prepared in the same manner as that adopted for preparing the resin particle dispersion. That is, the volume-average particle size of the particles, the dispersion medium, the dispersion method, and the content of the particles in the resin particle dispersion are also applied to the colorant to be dispersed in the colorant dispersion and the release agent particles to be dispersed in the release agent particle dispersion.

### First Aggregated Particle-Forming Step

Next, the first resin particle dispersion is mixed with the colorant dispersion and the release agent particle dispersion.

In the mixed dispersion, the first resin particles, the colorant, and the release agent particles are hetero-aggregated to form the first aggregated particles including the first resin particles, the colorant, and the release agent particles.

Specifically, for example, an aggregating agent is added to a dispersion obtained by mixing the first resin particle dispersion, the colorant dispersion, and the release agent particle dispersion; the pH of the mixed dispersion is adjusted to acidic (for example, pH of 2 or more and 5 or less); a dispersion stabilizer is added thereto as necessary; the temperature is set to a temperature region of 20° C. or higher and 50° C. or lower; and the particles dispersed in the mixed dispersion are aggregated to form the first aggregated particles.

In the first aggregated particle-forming step, for example, in a state where the mixed dispersion is stirred with a rotary shearing homogenizer, the aggregating agent may be added thereto at room temperature (for example, 25° C.), the pH of the mixed dispersion may be adjusted such that the dispersion is acidic (for example, pH of 2 or higher and 5 or lower), a dispersion stabilizer may be added to the dispersion as necessary, and then the dispersion may be heated.

Examples of the aggregating agent include a surfactant having polarity opposite to the polarity of the surfactant used as a dispersant added to the mixed dispersion, an inorganic metal salt, and a metal complex having a valency of 2 or higher. In particular, in a case where a metal complex is used as the aggregating agent, the amount of the surfactant used is reduced, and the charging characteristics are improved.

An additive that forms a complex or a bond similar to the complex with a metal ion of the aggregating agent may be used as necessary. As such an additive, a chelating agent is used.

Examples of the inorganic metal salt include metal salts such as calcium chloride, calcium nitrate, barium chloride, magnesium chloride, zinc chloride, aluminum chloride, and aluminum sulfate; and inorganic metal salt polymers such as polyaluminum chloride, polyaluminum hydroxide, and calcium polysulfide.

As the chelating agent, a water-soluble chelating agent may also be used. Examples of the chelating agent include oxycarboxylic acids such as tartaric acid, citric acid, and gluconic acid, iminodiacetic acid (IDA), nitrilotriacetic acid (NTA), and ethylenediaminetetraacetic acid (EDTA).

The amount of the chelating agent added with respect to 100 parts by mass of the first resin particles is, for example, preferably 0.01 parts by mass or more and 5.0 parts by mass or less, and more preferably 0.1 parts by mass or more and less than 3.0 parts by mass.

### Second Aggregated Particle-Forming Step

Next, after obtaining the first aggregated particle dispersion in which the first aggregated particles are dispersed, a second resin particle dispersion in which second resin particles are dispersed is added to the first aggregated particle dispersion.

The second resin particles may be of the same type as the first resin particles, or may be of different types.

Next, the second resin particles are aggregated on the surface of the first aggregated particles in the dispersion of the first aggregated particles and the second resin particles. In this case, by adding the release agent particle dispersion, the second resin particles and the release agent particles may be aggregated on the surface of the first aggregated particles. Specifically, for example, in the first aggregated particle-forming step, in a case where the first aggregated particles reach a target particle size, the second resin particle dispersion is added to the first aggregated particle dispersion, and the mixture is heated at a temperature equal to or lower than the glass transition temperature of the second resin particles.

By setting the pH of the dispersion in a range of, for example, about 6.5 or more and 8.5 or less, the progress of aggregation is stopped.

In this way, the second aggregated particles are obtained in which the second resin particles are aggregated so as to adhere to the surface of the first aggregated particles.

### Coalescence Step

Next, the second aggregated particle dispersion in which the second aggregated particles are dispersed is heated to, for example, a temperature equal to or higher than the glass transition temperatures of the first and second resin particles (for example, a temperature higher than the glass transition temperatures of the first and second resin particles by 10° C. to 30° C.) such that the second aggregated particles coalesce, thereby forming toner particles.

The toner particles are obtained through the above steps.

In the aggregation and coalescence method described above, the first aggregated particles may be coalesced to form the toner particles without performing the second aggregated particle-forming step. In addition, the second aggregated particle-forming step may be repeated a plurality of times.

After the coalescence step, the toner particles formed in a solution undergo a known washing step, solid-liquid separation step, and drying step, thereby obtaining dry toner particles.

The washing step is not particularly limited. However, in view of charging properties, displacement washing may be thoroughly performed using deionized water. The solid-liquid separation step is not particularly limited. However, in view of productivity, suction filtration, pressure filtration, or the like may be performed. Furthermore, the method of the drying step is not particularly limited. However, in view of productivity, freeze drying, flush drying, fluidized drying, vibratory fluidized drying, or the like may be performed.

For example, by adding an external additive to the obtained dry toner particles and mixing the external additive and the toner particles together, the toner according to the present exemplary embodiment is manufactured. The mixing may be performed, for example, using a V blender, a Henschel mixer, a Lödige mixer, or the like. Furthermore, coarse particles of the toner may be removed as necessary by using a vibratory sieving machine, a pneumatic sieving machine, or the like.

### Electrostatic Charge Image Developer

The electrostatic charge image developer according to the present exemplary embodiment contains at least the toner according to the present exemplary embodiment.

The electrostatic charge image developer according to the present exemplary embodiment may be a one-component developer that contains only the toner according to the present exemplary embodiment or a two-component developer that is obtained by mixing the toner and a carrier together.

The carrier is not particularly limited, and examples thereof include known carriers. Examples of the carrier include a coated carrier obtained by coating the surface of a core material consisting of magnetic powder with a coating resin; a magnetic powder dispersion-type carrier obtained by dispersing magnetic powder in a matrix resin and mixing the powder and the resin together; and a resin impregnation-type carrier obtained by impregnating porous magnetic powder with a resin.

Each of the magnetic powder dispersion-type carrier and the resin impregnation-type carrier may be a carrier obtained by coating a core material, that are particles configuring the carrier, with a coating resin.

Examples of the magnetic powder include magnetic metals such as iron, nickel, and cobalt; and magnetic oxides such as ferrite and magnetite.

Examples of the coating resin and the matrix resin include a styrene (meth)acrylic acid resin; polyolefin-based resins such as a polyethylene resin and a polypropylene resin; polyvinyl-based or polyvinylidene-based resins such as polystyrene, a (meth)acrylic resin, polyacrylonitrile, polyvinyl acetate, polyvinyl alcohol, polyvinyl butyral, polyvinyl chloride, polyvinylcarbazole, polyvinyl ether, or polyvinyl ketone; a vinyl chloride vinyl acetate copolymer; a straight silicone resin consisting of an organosiloxane bond or a modified product thereof, a fluororesin such as polytetrafluoroethylene, polyvinyl fluoride, polyvinylidene fluoride, or polychlorotrifluoroethylene; polyester; polyurethane; polycarbonate; an amino resin such as a urea formaldehyde resin; and an epoxy resin.

For example, the coating resin and the matrix resin preferably contain a (meth)acrylic resin, more preferably contain 50% by mass or more of the (meth)acrylic resin with respect to the total mass of the resin, and still more preferably contain 80% by mass or more of the (meth)acrylic resin with respect to the total mass of the resin.

In particular, for example, the coating resin and the matrix resin preferably contain an alicyclic (meth)acrylic resin as the (meth)acrylic resin.

The coating resin and the matrix resin may contain other additives such as conductive particles.

Examples of the conductive particles include metals such as gold, silver, and copper, and particles such as carbon black, titanium oxide, zinc oxide, tin oxide, barium sulfate, aluminum borate, and potassium titanate.

The surface of the core material is coated with a coating resin, for example, by a coating method using a solution for forming a coating layer obtained by dissolving the coating resin and various additives, that are used as necessary, in an appropriate solvent, and the like. The solvent is not particularly limited, and may be selected in consideration of the type of the coating resin used, coating suitability, and the like.

Specifically, examples of the resin coating method include a dipping method of dipping the core material in the solution for forming a coating layer; a spray method of spraying the solution for forming a coating layer to the surface of the core material; a fluidized bed method of spraying the solution for forming a coating layer to the core material that is floating by an air flow; and a kneader coater method of mixing the core material of the carrier with the solution for forming a coating layer in a kneader coater and removing solvents.

The mixing ratio (mass ratio) between the toner and the carrier, represented by toner:carrier, in the two-component developer is, for example, preferably 1:100 to 30:100, and more preferably 3:100 to 20:100.

### Image Forming Apparatus and Image Forming Method

The image forming apparatus and image forming method according to the present exemplary embodiment will be described.

The image forming apparatus according to the present exemplary embodiment includes an image holder, a charging device that charges the surface of the image holder, an electrostatic charge image forming device that forms an electrostatic charge image on the charged surface of the image holder, a developing device that contains an electrostatic charge image developer and develops the electrostatic charge image formed on the surface of the image holder as a toner image by using the electrostatic charge image developer, a transfer device that transfers the toner image formed on the surface of the image holder to the surface of a recording medium, and a fixing device that fixes the toner image transferred to the surface of the recording medium. As the electrostatic charge image developer, the electrostatic charge image developer according to the present exemplary embodiment is used.

In the image forming apparatus according to the present exemplary embodiment, an image forming method (image forming method according to the present exemplary embodiment) is performed that has a charging step of charging the surface of the image holder, an electrostatic charge image forming step of forming an electrostatic charge image on the charged surface of the image holder, a developing step of developing the electrostatic charge image formed on the surface of the image holder as a toner image by using the electrostatic charge image developer according to the present exemplary embodiment, a transfer step of transferring the toner image formed on the surface of the image holder to the surface of a recording medium, and a fixing step of fixing the toner image transferred to the surface of the recording medium.

As the image forming apparatus according to the present exemplary embodiment, known image forming apparatuses are used, such as a direct transfer-type apparatus that transfers a toner image formed on the surface of the image holder directly to a recording medium; an intermediate transfer-type apparatus that performs primary transfer by which the toner image formed on the surface of the image holder is transferred to the surface of an intermediate transfer member and secondary transfer by which the toner image transferred to the surface of the intermediate transfer member is transferred to the surface of a recording medium; an apparatus including a cleaning device that cleans the surface of the image holder before charging after the transfer of the toner image; and an apparatus including a charge neutralization device that neutralizes charge by irradiating the surface of the image holder with charge neutralizing light before charging after the transfer of the toner image.

In the case of the intermediate transfer-type apparatus, as the transfer device, for example, a configuration is adopted that has an intermediate transfer member with surface on which the toner image will be transferred, a primary transfer device that performs primary transfer to transfer the toner image formed on the surface of the image holder to the surface of the intermediate transfer member, and a secondary transfer device that performs secondary transfer to transfer the toner image transferred to the surface of the intermediate transfer member to the surface of a recording medium.

In the image forming apparatus according to the present exemplary embodiment, for example, a portion including the developing device may be a cartridge structure (process cartridge) to detachable from the image forming apparatus. As the process cartridge, for example, a process cartridge is suitably used that includes a developing device that contains the electrostatic charge image developer according to the present exemplary embodiment.

An example of the image forming apparatus according to the present exemplary embodiment will be shown below, but the present invention is not limited thereto. Hereinafter, among the parts shown in the drawing, main parts will be described, and others will not be described.

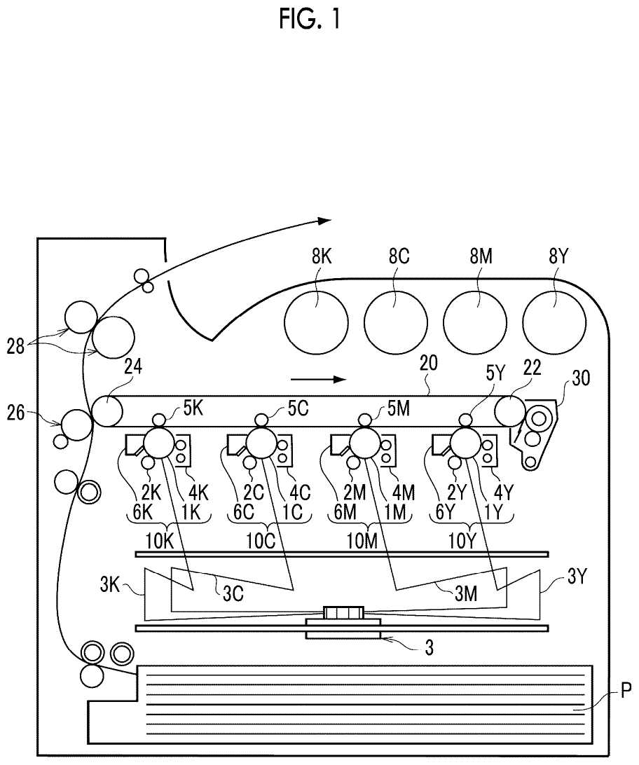

FIG. 1 is a view schematically showing the configuration of the image forming apparatus according to the present exemplary embodiment.

The image forming apparatus shown in FIG. 1 includes first to fourth image forming units 10Y, 10M, 10C, and 10K adopting an electrophotographic method that output images of colors, yellow (Y), magenta (M), cyan (C), and black (K), based on color-separated image data.

These image forming units (hereinafter, simply called “units” in some cases) 10Y, 10M, 10C, and 10K are arranged in a row in the horizontal direction in a state of being spaced apart by a predetermined distance. The units 10Y, 10M, 10C, and 10K may be process cartridges that are attached to and detached from the image forming apparatus.

An intermediate transfer belt 20 as an intermediate transfer member passing through the units 10Y, 10M, 10C, and 10K extends above the units in the drawing. The intermediate transfer belt 20 is looped over a driving roll 22 and a support roll 24 that in contact with the inner surface of the intermediate transfer belt 20, the rolls 22 and 24 being spaced apart in the horizontal direction in the drawing. The intermediate transfer belt 20 is designed to run in a direction toward the fourth unit 10K from the first unit 10Y Force is applied to the support roll 24 in a direction away from the driving roll 22 by a spring or the like (not shown in the drawing). Tension is applied to the intermediate transfer belt 20 looped over the two rolls. An intermediate transfer member cleaning device 30 facing the driving roll 22 is provided on the outer peripheral surface of the intermediate transfer belt 20.

In addition, a toner including toners having four colors of yellow, magenta, cyan, and black, that are contained in containers of toner cartridges 8Y, 8M, 8C, and 8K, is supplied to developing devices (example of the developing device) 4Y, 4M, 4C, and 4K of the units 10Y, 10M, 10C, and 10K, respectively.

The first to fourth units 10Y, 10M, 10C, and 10K have the same configuration. Therefore, in the present specification, as a representative, the first unit 10Y will be described that placed on the upstream side of the running direction of the intermediate transfer belt and forms a yellow image. Reference numerals marked with magenta (M), cyan (C), and black (K) instead of yellow (Y) are assigned in the same portions as in the first unit 10Y, such that the second to fourth units 10M, 10C, and 10K will not be described again.

The first unit 10Y has a photoreceptor 1Y that acts as an image holder. Around the photoreceptor 1Y, a charging roll (an example of the charging device) 2Y that charges the surface of the photoreceptor 1Y at a predetermined potential, an exposure device (an example of the electrostatic charge image forming device) 3 that exposes the charged surface to a laser beam 3Y based on color-separated image signals to form an electrostatic charge image, a developing device (an example of the developing device) 4Y that develops the electrostatic charge image by supplying a charged toner to the electrostatic charge image, a primary transfer roll (an example of the primary transfer device) 5Y that transfers the developed toner image onto the intermediate transfer belt 20, and a photoreceptor cleaning device (an example of the cleaning device) 6Y that removes the residual toner on the surface of the photoreceptor 1Y after the primary transfer are arranged in this order.

The primary transfer roll 5Y is disposed on the inner side of the intermediate transfer belt 20, at a position facing the photoreceptor 1Y. Furthermore, a bias power supply (not shown in the drawing) for applying a primary transfer bias is connected to each of primary transfer rolls 5Y, 5M, 5C, and 5K. Each bias power supply varies the transfer bias applied to each primary transfer roll under the control of a control unit not shown in the drawing.

Hereinafter, the operation that the first unit 10Y carries out to form a yellow image will be described.

First, prior to the operation, the surface of the photoreceptor 1Y is charged to a potential of −600 V to −800 V by the charging roll 2Y.

The photoreceptor 1Y is formed of a photosensitive layer laminated on a conductive (for example, volume resistivity at 20° C.: 1×10⁻⁶ Ω·cm or less) substrate. The photosensitive layer has properties in that although this layer usually has a high resistance (resistance of a general resin), in a case where the photosensitive layer is irradiated with the laser beam 3Y, the specific resistance of the portion irradiated with the laser beam changes. Therefore, via an exposure device 3, the laser beam 3Y is output to the surface of the charged photoreceptor 1Y according to the image data for yellow transmitted from the control unit not shown in the drawing. The laser beam 3Y is radiated to the photosensitive layer on the surface of the photoreceptor 1Y As a result, an electrostatic charge image of a yellow image pattern is formed on the surface of the photoreceptor 1Y.

The electrostatic charge image is an image formed on the surface of the photoreceptor 1Y by charging. This image is a so-called negative latent image formed in a manner in which the charges with which the surface of the photoreceptor 1Y is charged flow due to the reduction in the specific resistance of the portion of the photosensitive layer irradiated with the laser beam 3Y, but the charges in a portion not being irradiated with the laser beam 3Y remain.

The electrostatic charge image formed on the photoreceptor 1Y rotates to a predetermined development position as the photoreceptor 1Y runs. At the development position, the electrostatic charge image on the photoreceptor 1Y turns into a visible image (developed image) as a toner image by the developing device 4Y.

The developing device 4Y contains, for example, an electrostatic charge image developer that contains at least a yellow toner and a carrier. By being stirred in the developing device 4Y, the yellow toner undergoes triboelectrification, carries charges of the same polarity (negative polarity) as the charges with which the surface of the photoreceptor 1Y is charged, and is held on a developer roll (an example of a developer holder). As the surface of the photoreceptor 1Y passes through the developing device 4Y, the yellow toner electrostatically adheres to the neutralized latent image portion on the surface of the photoreceptor 1Y, and the latent image is developed by the yellow toner. The photoreceptor 1Y on which the yellow toner image is formed keeps on running at a predetermined speed, and the toner image developed on the photoreceptor 1Y is transported to a predetermined primary transfer position.

In a case where the yellow toner image on the photoreceptor 1Y is transported to the primary transfer position, a primary transfer bias is applied to the primary transfer roll 5Y, and electrostatic force heading for the primary transfer roll 5Y from the photoreceptor 1Y acts on the toner image. As a result, the toner image on the photoreceptor 1Y is transferred onto the intermediate transfer belt 20. The transfer bias applied at this time has a polarity (+) opposite to the polarity (−) of the toner. For example, in the first unit 10Y, the transfer bias is set to +10 μA under the control of the control unit (not shown in the drawing).

On the other hand, the residual toner on the photoreceptor 1Y is removed by a photoreceptor cleaning device 6Y and collected.

In addition, the primary transfer bias applied to the primary transfer rolls 5M, 5C, and 5K following the second unit 10M is also controlled according to the first unit.

In this way, the intermediate transfer belt 20 to which the yellow toner image is transferred in the first unit 10Y is sequentially transported through the second to fourth units 10M, 10C, and 10K, and the toner images of each color are superimposed and transferred in layers.

The intermediate transfer belt 20, to which the toner images of four colors are transferred in layers through the first to fourth units, reaches a secondary transfer portion configured with the intermediate transfer belt 20, the support roll 24 in contact with the inner surface of the intermediate transfer belt, and a secondary transfer roll (an example of the secondary transfer device) 26 disposed on the outer peripheral surface of the intermediate transfer belt 20. On the other hand, via a supply mechanism, recording paper P (an example of recording medium) is supplied at a predetermined timing to the gap between the secondary transfer roll 26 and the intermediate transfer belt 20 that are in contact with each other. Furthermore, secondary transfer bias is applied to the support roll 24. The transfer bias applied at this time has the same polarity (−) as the polarity (−) of the toner. The electrostatic force heading for the recording paper P from the intermediate transfer belt 20 acts on the toner image, that makes the toner image on the intermediate transfer belt 20 transferred onto the recording paper P. The secondary transfer bias to be applied at this time is determined according to the resistance detected by a resistance detecting device (not shown in the drawing) for detecting the resistance of the secondary transfer portion, and the voltage thereof is controlled.

Thereafter, the recording paper P is transported into a pressure contact portion (nip portion) of a pair of fixing rolls in the fixing device 28 (an example of the fixing device), the toner image is fixed to the surface of the recording paper P, and a fixed image is formed.

Examples of the recording paper P to which the toner image is to be transferred include plain paper used in electrophotographic copy machines, printers, and the like. Examples of the recording medium also include an OHP sheet, in addition to the recording paper P.

In order to further improve the smoothness of the image surface after fixing, for example, it is preferable that the surface of the recording paper P is also smooth. For example, coated paper prepared by coating the surface of plain paper with a resin or the like, art paper for printing, and the like are suitably used.

The recording paper P on which the colored image has been fixed is transported to an output portion, and a series of colored image forming operations is finished.

### Process Cartridge and Toner Cartridge

The process cartridge according to the present exemplary embodiment will be described.

The process cartridge according to the present exemplary embodiment includes a developing device that contains the electrostatic charge image developer according to the present exemplary embodiment and develops an electrostatic charge image formed on the surface of an image holder as a toner image by using the electrostatic charge image developer. The process cartridge is detachable from the image forming apparatus.

The process cartridge according to the present exemplary embodiment is not limited to the above configuration. The process cartridge may be configured with a developing device and, for example, at least one member selected from other devices, such as an image holder, a charging device, an electrostatic charge image forming device, and a transfer device, as necessary.

An example of the process cartridge according to the present exemplary embodiment will be shown below, but the present invention is not limited thereto. Hereinafter, among the parts shown in the drawing, main parts will be described, and others will not be described.

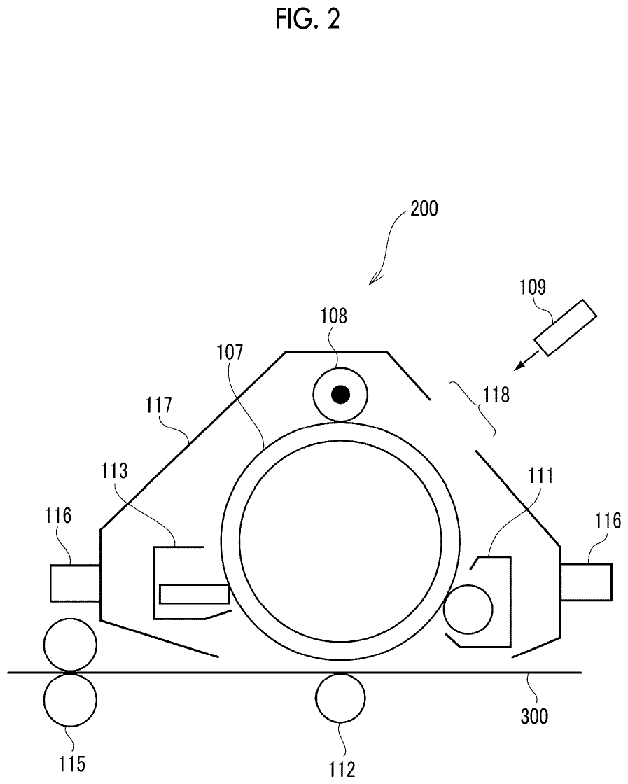

FIG. 2 is a view schematically showing the configuration of the process cartridge according to the present exemplary embodiment.

A process cartridge 200 shown in FIG. 2 is configured, for example, with a housing 117 that includes mounting rails 116 and an opening portion 118 for exposure, a photoreceptor 107 (an example of image holder), a charging roll 108 (an example of charging device) that is provided on the periphery of the photoreceptor 107, a developing device 111 (an example of developing device), a photoreceptor cleaning device 113 (an example of cleaning device), that are integrally combined and held in the housing 117. The process cartridge 200 forms a cartridge in this way.

In FIG. 2, 109 represents an exposure device (an example of electrostatic charge image forming device), 112 represents a transfer device (an example of transfer device), 115 represents a fixing device (an example of fixing device), and 300 represents recording paper (an example of recording medium).

Next, the toner cartridge according to the present exemplary embodiment will be described.

The toner cartridge according to the present exemplary embodiment is a toner cartridge including a container that contains the toner according to the present exemplary embodiment and is detachable from the image forming apparatus. The toner cartridge includes a container that contains a replenishing toner to be supplied to the developing device provided in the image forming apparatus.

The image forming apparatus shown in FIG. 1 is an image forming apparatus having a configuration that enables toner cartridges 8Y, 8M, 8C, and 8K to be detachable from the apparatus. The developing devices 4Y, 4M, 4C, and 4K are connected to toner cartridges corresponding to the respective developing devices (colors) by a toner supply pipe not shown in the drawing. In addition, in a case where the amount of the toner contained in the container of the toner cartridge is low, the toner cartridge is replaced.

### EXAMPLES

Hereinafter, exemplary embodiments of the present invention will be specifically described based on Examples. However, the exemplary embodiments of the present invention are not limited to Examples. In the following description, unless otherwise specified, “parts” and “%” are based on mass.

### Production of Various Dispersions

### Synthesis of Amorphous Polyester Resin (A)

Terephthalic acid: 68 parts
Fumaric acid: 32 parts
Ethylene glycol: 42 parts
1,5-Pentanediol: 47 parts

The above-described materials are charged into a flask equipped with a stirring device, a nitrogen introduction pipe, a temperature sensor, and a rectification column, the temperature of the reaction solution is raised to 220° C. over 1 hour under nitrogen gas stream, and 1 part of titanium tetraethoxide with respect to the total of 100 parts of the above-described materials is added thereto. While the generated water is distilled off, the temperature is raised to 240° C. over 0.5 hours, a dehydration condensation reaction is continued for 1 hour at 240° C., and then the reaction product is cooled. In this manner, an amorphous polyester resin (A) having a weight-average molecular weight of 97,000 and a glass transition temperature of 60° C. is obtained.

### Production of Amorphous Polyester Resin Particle Dispersion (A1)

40 parts of ethyl acetate and 25 parts of 2-butanol are put in a container equipped with a temperature control unit and a nitrogen purge unit, thereby preparing a mixed solvent. Thereafter, 100 parts of the amorphous polyester resin (A) is slowly added to and dissolved in the solvent, a 10% ammonia aqueous solution (in an amount equivalent to 3 times the acid value of the resin in terms of molar ratio) is added thereto, and the mixed solution is stirred for 30 minutes. Next, the inside of the container is replaced with dry nitrogen, the temperature is kept at 40° C., and 400 parts of deionized water is added dropwise thereto while stirring the mixed solution for emulsification. After the dropwise addition is completed, the emulsion is returned to 25° C., thereby obtaining a resin particle dispersion in which resin particles having a volume-average particle size of 195 nm are dispersed. Deionized water is added to the resin particle dispersion such that the solid content reaches 20%, thereby obtaining an amorphous polyester resin particle dispersion (A1) in which particles of the amorphous polyester resin (A) are dispersed.

### Production of Crystalline Polyester Resin Particle Dispersion (B1)

1,10-Decanedicarboxylic acid: 260 parts
1,6-Hexanediol: 167 parts
Dibutyl tin oxide (catalyst): 0.3 parts

The above-described materials are charged into a heated and dried three-neck flask, the air in the three-neck flask is replaced with nitrogen gas to be under an inert atmosphere, and the mixture is stirred and refluxed at 180° C. for 5 hours by mechanical stirring. Next, the temperature is slowly raised to 230° C. under reduced pressure, and the components are stirred for 2 hours. At a point in time when the components have turned viscous, the reaction system is air-cooled such that the reaction is stopped. In this way, a crystalline polyester resin having a weight-average molecular weight of 12,500 and a melting temperature of 73° C. is obtained. 90 parts of the crystalline polyester resin, 1.8 parts of an anionic surfactant (TaycaPower, manufactured by Tayca Corporation, solid content: 12%, sodium dodecylbenzene sulfonate), and 210 parts of deionized water are mixed with each other, heated to 120° C., and dispersed using a homogenizer (ULTRA-TURRAX T50, manufactured by IKA) and then subjected to a dispersion treatment for 1 hour with a pressure jet type homogenizer to obtain a resin particle dispersion in which resin particles having a volume-average particle size of 195 nm are dispersed. Deionized water is added to the resin particle dispersion such that the solid content reaches 20%, thereby obtaining a crystalline polyester resin particle dispersion (B1) in which particles of the crystalline polyester resin are dispersed.

### Production of Styrene Acrylic Resin Particle Dispersion (S1)

Styrene: 375 parts
n-Butyl acrylate: 25 parts
Acrylic acid: 2 parts
Dodecanethiol: 24 parts
Carbon tetrabromide: 4 parts

A mixture obtained by mixing and dissolving the above-described materials is dispersed and emulsified in a surfactant solution obtained by dissolving 6 parts of a nonionic surfactant (manufactured by Sanyo Chemical Industries, Ltd., NONIPOL 400) and 10 parts of an anionic surfactant (TaycaPower, manufactured by Tayca Co., Ltd., solid content: 12% by mass, sodium dodecylbenzenesulfonate) in 550 parts of deionized water in a flask. Next, the mixture in the flask is stirred, and in this state, an aqueous solution obtained by dissolving 4 parts of ammonium persulfate in 50 parts of deionized water is added thereto for 20 minutes. Next, nitrogen purging is performed, and in a state in which the mixture in the flask is stirred, the flask is heated in an oil bath until the temperature of the content reaches 70° C., and the temperature is kept at 70° C. for 5 hours so that emulsion polymerization continues. In this way, a resin particle dispersion in which resin particles having a volume-average particle size of 150 nm, a weight-average molecular weight (Mw) of 32,000, and a glass transition temperature (Tg) of 57° C. are dispersed is obtained. Deionized water is added to the resin particle dispersion such that the solid content thereof is adjusted to 20%, thereby obtaining a styrene acrylic resin particle dispersion (S1) in which particles of the styrene acrylic resin are dispersed.

### Production of Colorant Particle Dispersion (Cy1)

C. I. Pigment Blue 15:3 (manufactured by Dainichiseika Color & Chemicals Mfg. Co., Ltd.): 70 parts
Anionic surfactant (NEOGEN RK manufactured by DKS Co. Ltd.): 1 part
Deionized water: 200 parts

The above-described materials are mixed together and dispersed for 10 minutes using a homogenizer (ULTRA-TURRAX T50 manufactured by IKA). Deionized water is added thereto such that the solid content in the dispersion is 20%, thereby obtaining a colorant particle dispersion (Cy1) in which colorant particles having a volume-average particle size of 190 nm are dispersed.

### Production of Release Agent Particle Dispersion (W1)

Ester-based wax (pentaerythritol behenic acid ester wax, manufactured by NOF Corporation, product name: WEP5, melting temperature: 76° C.): 100 parts
Anionic surfactant: 1 part

(TaycaPower, manufactured by Tayca Corporation, solid content: 12%, sodium dodecylbenzenesulfonate)
Deionized water: 350 parts

The above materials are mixed together, heated to 100° C., and dispersed using a homogenizer (ULTRA-TURRAX T50 manufactured by IKA). By using a pressure jet-type Gorlin homogenizer, a dispersion treatment is performed, thereby obtaining a release agent particle dispersion in which release agent particles having a volume-average particle size of 1,000 nm are dispersed. Deionized water is added to the release agent particle dispersion such that the amount of solid content thereof is adjusted to 20%, thereby obtaining a release agent particle dispersion (W1).

### Preparation of Release Agent Particle Dispersion (W2)

First, the following samples are prepared in order to prepare a release agent particle dispersion (W2).
Polyethylene-based wax (hydrocarbon-based wax, Polywax (registered trademark) 725 manufactured by Baker Petrolite Corporation, melting temperature: 104° C.): 270 parts
Anionic surfactant (NEOGEN RK manufactured by DKS Co., Ltd.): 13.5 parts
Deionized water: 21.6 parts

Next, the above-described three samples are mixed together, the polyethylene-based wax (Polywax 725) is dissolved using a pressure-type homogenizer (Gaulin homogenizer manufactured by Gaulin Corporation), and the dispersion treatment of the polyethylene-based wax (Polywax 725) is performed at a pressure of 5 MPa for 120 minutes and further at a pressure of 40 MPa for 360 minutes, thereby obtaining a mixed solution. The obtained mixed solution is cooled, and deionized water is added thereto to obtain a release agent particle dispersion (W2) in which a concentration of solid contents is adjusted to 20.0%.

A volume-average particle size of the particles in the obtained release agent particle dispersion (W2) is 225 nm.

### Production of Toner

### Production of Toner 1

### Aggregated Particle-Forming Step

Deionized water: 200 parts
Colorant particle dispersion (Cy1): 15 parts
Release agent particle dispersion (W1): 10.0 parts
Styrene acrylic resin particle dispersion (S1): 107 parts
Amorphous polyester resin particle dispersion (A1): 100 parts
Crystalline polyester resin particle dispersion (B1): 10 parts
Anionic surfactant (TaycaPower, manufactured by Tayca Corporation, solid content: 12%, sodium dodecylbenzenesulfonate): 0.25 parts

The above-described materials are charged into a round stainless steel flask, 0.1 N (0.1 mol/L) nitric acid is added thereto to adjust the pH to 3.5, and then a magnesium chloride aqueous solution obtained by dissolving 6 parts of magnesium chloride in 30 parts of deionized water and a dodecyltrimethylammonium bromide aqueous solution obtained by dissolving 5.5 parts of dodecyltrimethylammonium bromide in 60 parts of deionized water are added thereto. The mixture is dispersed at 30° C. using a homogenizer (Ultra-Turrax T50 manufactured by IKA), and the temperature is raised. The mixture is heated in an oil bath for heating up to 45° C. while sequentially confirming the aggregated particle diameter, and the temperature is maintained until the volume-average particle size reaches 4.9 m, thereby obtaining first aggregated particles (first aggregated particle-forming step).

38 parts of the styrene acrylic resin particle dispersion (S1) and 35 parts of the amorphous polyester resin particle dispersion (A1) are gently added as shell components to the dispersion containing the first aggregated particles prepared as described above, and the temperature of the heating jacket is further raised and maintained at 50° C. for 1 hour. 0.04 parts of ozone water (3 ppm, produced using Ozone Buster Industry manufactured by Earth walker Trading) is added thereto to obtain second aggregated particles. In a case where a volume-average particle size of the obtained second aggregated particles is measured, the volume-average particle size is 5.4 μm (second aggregated particle-forming step).

Thereafter, 20 parts of 10% ethylenediaminetetraacetic acid (EDTA) is added thereto while continuing the stirring, and then the pH is adjusted to 9.0 using a 1 N sodium hydroxide aqueous solution to stop the aggregation.

### Coalescence Step

Next, while continuing the stirring, the temperature is raised to 85° C. at a temperature raising rate of 0.05° C./min, maintained at 85° C. for 3 hours, and then lowered to 30° C. at a cooling rate of 15° C./min (first cooling). Next, the temperature is raised (re-heated) to 85° C. at a temperature raising rate of 0.2° C./min, maintained for 30 minutes, and then lowered to 30° C. at a cooling rate of 0.5° C./min (second cooling).

Next, the solid content is filtered, washed with 500 mL of deionized water three times, and dried to obtain toner particles 1 having a volume-average particle size of 5.2 m.

### External Addition of External Additive

100 parts of the toner particles and 1.5 parts of hydrophobic silica (RY50 manufactured by Nippon Aerosil Co., Ltd.) are mixed with each other using a sample mill at a rotation speed of 10,000 rpm for 30 seconds. The mixture is sieved with a vibrating sieve having an opening of 45 μm to obtain a toner 1.

### Production of Toner 2 to Toner 18, and Toner C1 to Toner C4

Toners 2 to 18 and toners C1 to C4 are obtained in the same manner as the toner 1, except that the amount of the styrene acrylic resin particle dispersion (S1) (in the table, “StAc”), the amount of the amorphous polyester resin particle dispersion (A1) (in the table, “Amorphous PES”), the amount of the crystalline polyester resin particle dispersion (B1) (in the table, “Crystalline PES”), the amount of the release agent particle dispersion (W1) (in the table, “Ester wax”), the amount of the release agent particle dispersion (W2) (in the table, “Paraffin wax”), the amount of the anionic surfactant (sodium dodecylbenzenesulfonate) (in the table, “Sulfur-containing solution”), the amount of the dodecyltrimethylammonium bromide (in the table, “Bromine-containing compound”), and the amount of the ozone water, that are used in the aggregated particle-forming step, are as shown in Table 1.

The amounts of the styrene acrylic resin particle dispersion (S1) and the amorphous polyester resin particle dispersion (A1) described in Table 1 are the total amount added in the first aggregated particle-forming step and the second aggregated particle-forming step. 74% of the total amount is used in the first aggregated particle-forming step, and 26% of the total amount is used in the second aggregated particle-forming step to produce the second aggregated particles.

### Measurement and Evaluation of Toner

### Measurement of Toner

In the obtained toner, the results of obtaining IBr, IS, and IO by the above-described methods are shown in Tables 2 and 3. In addition, the results of calculating IS/IBr and IBr/IO are shown in Tables 2 and 3.

### Production of Developer

### Production of Carrier (CA)

500 parts of spherical magnetite powder particles (volume-average particle diameter: 0.55 m) are agitated with a Henschel mixer, 5 parts of a titanate-based coupling agent is added thereto, and the mixture is heated to 100° C. and stirred for 30 minutes. Next, 6.25 parts of phenol, 9.25 parts of 35% formalin, 500 parts of magnetite particles treated with a titanate-based coupling agent, 6.25 parts of 25% aqueous ammonia, and 425 parts of water are put in a four-necked flask and agitated, and reacted at 85° C. for 120 minutes while being stirred. Thereafter, the reaction solution is cooled to 25° C., 500 parts of water is added thereto, the supernatant is removed, and the precipitate is washed with water. The precipitate washed with water is heated under reduced pressure and dried, thereby obtaining a carrier (CA) having an average particle size of 35 km.

### Production of Developer

Each toner and the carrier (CA) is put in a V blender at a mass ratio (toner/carrier)=5/95, and stirred for 20 minutes, thereby obtaining each developer.

### Evaluation of Toner Color Formability

Chroma of a color image that is a cyan solid image is obtained to evaluate the color formability of the toner. An image sample of Electrophotography Society Test Chart No. 5-1 is used for the output chart of the evaluation.

A total of 100 sheets of a color image in which the amount of the toner is adjusted to 4.5 g/m² is continuously formed, and one sheet is extracted from every 10 sheets to obtain a total of 10 sheets. For each of peripheral parts (10 mm from the end part) of each image and 10 locations inside the image, coordinate values (L* value, a* value, and b* value) of the CIE1976 L*a*b* color system are obtained using X-Rite 939 (aperture diameter: 4 mm) manufactured by X-Rite, Inc., and the chroma (C*) is obtained from the values by the following formula. Table 2 and Table 3 show the results of the evaluation of the chroma (C*) of the color image according to the following evaluation standard.

C*=((a*)²+(b*)²)^{1/2} Formula:

### Evaluation Standard for Chroma (C*)

A: 62≤C* (the chroma of the color image is not inhibited and is satisfactorily exhibited)
A−: 58≤C*<62 (the chroma of the color image is not inhibited and is satisfactorily exhibited)
B: 54≤C*<58 (the chroma of the color image is not inhibited)
B−: 50≤C*<54 (the chroma of the color image is not inhibited)
C: C*<50 (the chroma of the color image is inhibited and decreased)

TABLE 1

| | Addition amount (part) | | | | | | | |
|---|---|---|---|---|---|---|---|---|
| | | | | | | Sulfur- | Bromine- | |
| | | Amorphous | Crystalline | Ester | Paraffin | containing | containing | Ozone |
| Toner | StAc | PES | PES | wax | wax | solution | compound | water |
| 1 | 145 | 135 | 10 | 10.0 | 0.0 | 0.25 | 5.5 | 0.04 |
| 2 | 128 | 152 | 0 | 10.0 | 0.0 | 0.25 | 5.5 | 0.04 |
| 3 | 280 | 0 | 0 | 1.7 | 8.3 | 0.02 | 0.4 | 0.00 |
| 4 | 215 | 65 | 0 | 10.0 | 0.0 | 0.17 | 3.6 | 0.04 |
| 5 | 0 | 280 | 0 | 10.0 | 0.0 | 0.41 | 9.1 | 0.18 |
| 6 | 0 | 280 | 0 | 10.0 | 0.0 | 0.50 | 10.9 | 0.34 |
| 7 | 128 | 152 | 0 | 10.0 | 0.0 | 0.02 | 5.5 | 0.04 |
| 8 | 128 | 152 | 0 | 10.0 | 0.0 | 0.15 | 5.5 | 0.04 |
| 9 | 128 | 152 | 0 | 10.0 | 0.0 | 0.30 | 5.5 | 0.04 |
| 10 | 128 | 152 | 0 | 10.0 | 0.0 | 5.94 | 5.5 | 0.04 |
| 11 | 0 | 280 | 0 | 10.0 | 0.0 | 0.25 | 5.5 | 11.84 |
| 12 | 0 | 280 | 0 | 10.0 | 0.0 | 0.25 | 5.5 | 9.84 |
| 13 | 75 | 205 | 0 | 10.0 | 0.0 | 0.25 | 5.5 | 0.04 |
| 14 | 207 | 74 | 0 | 10.0 | 0.0 | 0.25 | 5.5 | 0.04 |
| 15 | 280 | 0 | 0 | 7.5 | 2.5 | 0.25 | 5.5 | 0.00 |
| 16 | 280 | 0 | 0 | 5.0 | 5.0 | 0.25 | 5.5 | 0.00 |
| 17 | 280 | 0 | 0 | 10.0 | 0.0 | 0.25 | 5.5 | 15.00 |
| 18 | 128 | 152 | 0 | 0.0 | 10.0 | 0.25 | 5.5 | 13.00 |
| C1 | 280 | 0 | 0 | 0.8 | 9.2 | 0.01 | 0.2 | 0.00 |
| C2 | 0 | 280 | 0 | 10.0 | 0.0 | 0.58 | 12.8 | 0.51 |
| C3 | 128 | 152 | 0 | 10.0 | 0.0 | 0.01 | 5.5 | 0.04 |
| C4 | 128 | 152 | 0 | 10.0 | 0.0 | 6.44 | 5.5 | 0.04 |

TABLE 2

| | Toner | IBr | IS | IS/IBr | IO | IBr/IO | Evaluation |
|---|---|---|---|---|---|---|---|
| Example 1 | 1 | 15 | 0.75 | 0.05 | 0.135 | 111 | A |
| Example 2 | 2 | 15 | 0.75 | 0.05 | 0.15 | 100 | A |
| Example 3 | 3 | 1 | 0.05 | 0.05 | 0.01 | 100 | B− |
| Example 4 | 4 | 10 | 0.50 | 0.05 | 0.10 | 100 | A− |
| Example 5 | 5 | 25 | 1.25 | 0.05 | 0.25 | 100 | A− |
| Example 6 | 6 | 30 | 1.50 | 0.05 | 0.30 | 100 | B− |
| Example 7 | 7 | 15 | 0.075 | 0.005 | 0.15 | 100 | B− |
| Example 8 | 8 | 15 | 0.45 | 0.03 | 0.15 | 100 | A− |
| Example 9 | 9 | 15 | 0.90 | 0.06 | 0.15 | 100 | A− |
| Example 10 | 10 | 15 | 18.00 | 1.20 | 0.15 | 100 | B− |
| Example 11 | 11 | 15 | 0.75 | 0.05 | 3.75 | 4.00 | B− |
| Example 12 | 12 | 15 | 0.75 | 0.05 | 3.15 | 4.76 | A− |

TABLE 3

| | Toner | IBr | IS | IS/IBr | IO | IBr/IO | Evaluation |
|---|---|---|---|---|---|---|---|
| Example 13 | 13 | 15 | 0.75 | 0.05 | 0.18 | 83.3 | A |
| Example 14 | 14 | 15 | 0.75 | 0.05 | 0.105 | 143 | A |
| Example 15 | 15 | 15 | 0.75 | 0.05 | 0.045 | 333 | A− |
| Example 16 | 16 | 15 | 0.75 | 0.05 | 0.03 | 500 | B− |
| Example 17 | 17 | 15 | 0.75 | 0.05 | 0.15 | 100 | B− |
| Example 18 | 18 | 15 | 0.75 | 0.05 | 0.15 | 100 | A− |
| Comparative | C1 | 0.5 | 0.025 | 0.05 | 0.005 | 100 | C |
| Example 1 | | | | | | | |
| Comparative | C2 | 35 | 1.75 | 0.05 | 0.35 | 100 | C |
| Example 2 | | | | | | | |
| Comparative | C3 | 15 | 0.03 | 0.002 | 0.15 | 100 | C |
| Example 3 | | | | | | | |
| Comparative | C4 | 15 | 19.50 | 1.30 | 0.15 | 100 | C |
| Example 4 | | | | | | | |

From the above results, it is found that, in the present example, the chroma of the color image is high and the color formability of the toner is favorable, as compared with the comparative examples.

The present exemplary embodiment includes the following aspects.

(((1)))

An electrostatic charge image developing toner comprising:
toner particles containing a resin and a colorant,
wherein, in the toner particles, in a case where a Net intensity of a Br element measured by X-ray fluorescence analysis is denoted by IBr and a Net intensity of an S element measured by X-ray fluorescence analysis is denoted by IS,
   IBr is 1 kcps or more and 30 kcps or less, and
   IS/IBr is 0.005 or more and 1.2 or less.
      (((2)))

The electrostatic charge image developing toner according to (((1))),
wherein, in the toner particles, in a case where a Net intensity of an O element measured by X-ray fluorescence analysis is denoted by IO, IBr/O is 4.76 or more and 333 or less.
   (((3)))

The electrostatic charge image developing toner according to (((1))) or (((2))),
wherein the IBr is 10 kcps or more and 25 kcps or less.
   (((4)))

The electrostatic charge image developing toner according to (((3))),
wherein the IS/IBr is 0.03 or more and 0.06 or less.
   (((5)))

The electrostatic charge image developing toner according to any one of (((2))) to (((4))),
wherein the IBr/IO is 83.3 or more and 143 or less.
   (((6)))

The electrostatic charge image developing toner according to any one of (((1))) to (((5))),
wherein the resin includes a polyester resin.
   (((7)))

The electrostatic charge image developing toner according to any one of (((1))) to (((6))),
wherein the toner particles contain a release agent including an ester-based wax.
   (((8))) An electrostatic charge image developer comprising:
the electrostatic charge image developing toner according to any one of (((1))) to (((7))).
   (((9)))

A toner cartridge comprising:
a container that contains the electrostatic charge image developing toner according to any one of (((1))) to (((7))),
wherein the toner cartridge is detachable from an image forming apparatus.
   (((10)))

A process cartridge comprising:
a developing device that contains the electrostatic charge image developer according to (((8))) and develops an electrostatic charge image formed on a surface of an image holder as a toner image using the electrostatic charge image developer,
wherein the process cartridge is detachable from an image forming apparatus.
   (((11)))

An image forming apparatus comprising:
an image holder;
a charging device that charges a surface of the image holder;
an electrostatic charge image forming device that forms an electrostatic charge image on the charged surface of the image holder;
a developing device that contains the electrostatic charge image developer according to (((8))) and develops the electrostatic charge image formed on the surface of the image holder as a toner image using the electrostatic charge image developer;
a transfer device that transfers the toner image formed on the surface of the image holder to a surface of a recording medium; and
a fixing device that fixes the toner image transferred to the surface of the recording medium.
   (((12)))

An image forming method comprising:
charging a surface of an image holder;
forming an electrostatic charge image on the charged surface of the image holder;
developing the electrostatic charge image formed on the surface of the image holder as a toner image using the electrostatic charge image developer according to (((8)));
transferring the toner image formed on the surface of the image holder to a surface of a recording medium; and
fixing the toner image transferred to the surface of the recording medium.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrostatic charge image developing toner comprising:
toner particles containing a resin and a colorant,
wherein, in the toner particles, in a case where a Net intensity of a Br element measured by X-ray fluorescence analysis is denoted by IBr and a Net intensity of an S element measured by X-ray fluorescence analysis is denoted by IS,
IBr is 1 kcps or more and 30 kcps or less, and
IS/IBr is 0.005 or more and 1.2 or less.

2. The electrostatic charge image developing toner according to claim 1,
wherein, in the toner particles, in a case where a Net intensity of an O element measured by X-ray fluorescence analysis is denoted by IO, IBr/O is 4.76 or more and 333 or less.

3. The electrostatic charge image developing toner according to claim 1,
wherein the IBr is 10 kcps or more and 25 kcps or less.

4. The electrostatic charge image developing toner according to claim 3,
wherein the IS/IBr is 0.03 or more and 0.06 or less.

5. The electrostatic charge image developing toner according to claim 2,
wherein the IBr/O is 83.3 or more and 143 or less.

6. The electrostatic charge image developing toner according to claim 1,
wherein the resin includes a polyester resin.

7. The electrostatic charge image developing toner according to claim 1,
wherein the toner particles contain a release agent including an ester-based wax.

8. An electrostatic charge image developer comprising:
the electrostatic charge image developing toner according to claim 1.

9. An electrostatic charge image developer comprising:
the electrostatic charge image developing toner according to claim 2.

10. An electrostatic charge image developer comprising:
the electrostatic charge image developing toner according to claim 3.

11. An electrostatic charge image developer comprising:
the electrostatic charge image developing toner according to claim 4.

12. An electrostatic charge image developer comprising:
the electrostatic charge image developing toner according to claim 5.

13. An electrostatic charge image developer comprising:
the electrostatic charge image developing toner according to claim 6.

14. An electrostatic charge image developer comprising:
the electrostatic charge image developing toner according to claim 7.

15. A toner cartridge comprising:
a container that contains the electrostatic charge image developing toner according to claim 1,
wherein the toner cartridge is detachable from an image forming apparatus.

16. A toner cartridge comprising:
a container that contains the electrostatic charge image developing toner according to claim 2,
wherein the toner cartridge is detachable from an image forming apparatus.

17. A toner cartridge comprising:
a container that contains the electrostatic charge image developing toner according to claim 3,
wherein the toner cartridge is detachable from an image forming apparatus.

18. A process cartridge comprising:
a developing device that contains the electrostatic charge image developer according to claim 8 and develops an electrostatic charge image formed on a surface of an image holder as a toner image using the electrostatic charge image developer,
wherein the process cartridge is detachable from an image forming apparatus.

19. An image forming apparatus comprising:
an image holder;
a charging device that charges a surface of the image holder;
an electrostatic charge image forming device that forms an electrostatic charge image on the charged surface of the image holder;
a developing device that contains the electrostatic charge image developer according to claim 8 and develops the electrostatic charge image formed on the surface of the image holder as a toner image using the electrostatic charge image developer;
a transfer device that transfers the toner image formed on the surface of the image holder to a surface of a recording medium; and
a fixing device that fixes the toner image transferred to the surface of the recording medium.

20. An image forming method comprising:
charging a surface of an image holder;
forming an electrostatic charge image on the charged surface of the image holder;
developing the electrostatic charge image formed on the surface of the image holder as a toner image using the electrostatic charge image developer according to claim 8;
transferring the toner image formed on the surface of the image holder to a surface of a recording medium; and
fixing the toner image transferred to the surface of the recording medium.
